(19) United States
(12) Patent Application Publication
(10) Pub. No.: US 2025/0188735 A1
(43) Pub. Date: Jun. 12, 2025

(54) Method of constructing a structure with construction aids that are designed for permanent residence in the structure

(71) Applicant: Boudali Bahri, Leiden (NL)

(72) Inventor: Boudali Bahri, Leiden (NL)

(21) Appl. No.: 18/844,958

(22) PCT Filed: Nov. 23, 2022
(86) PCT No.: PCT/NL2022/000008

§ 371 Date: Sep. 8, 2024

(30) Foreign Application Priority Data
Dec. 1, 2021 (NL) 1044222

(51) Int. Cl. E04B 1/35; B66C 23/26; E04B 1/343; E04B 1/346

(52) U.S. Cl. CPC E04B 1/3544; B66C 23/26; E04B 1/34312; E04B 1/346; E04B 2001/3588

(57) ABSTRACT

The solution relates to a unique concept and an efficient construction method and device to enable faster construction by, inter alia, avoiding as much unnecessary work as possible, speeding up the assembly time of building structures and building materials and minimizing dismantling of, inter alia, hoisting cranes or as much as possible. Avoid temporary building constructions such as construction lift systems and a lifting shed. Methods and devices for building a structure such as relatively high, multi-story buildings include building the structure using construction aids which are at least partly adapted to act as functional part of the structure to be and remain permanently incorporated into the structure. A tower and/or hoisting machine of a construction crane or construction lift can be used as a permanent part of the construction, such as part of a lift installation, after the construction phase of the construction work.

The invention relates to a process for building a structure under the use of construction aids, such as lifting and/or assembly tools.

In the construction industry, one often faces costly delays for the delivery of buildings at an agreed time as per the contracts and that especially on large projects and that is often the cause of major budgetary and economic problems within the construction industry. This is often due to unnecessary and superfluous work which is certainly and potentially avoidable such as assembly, dismantling, dismantling and transport of materials and heavy structures, components including cranes, temporary construction lift systems and/or a lifting shed (a platform as a temporary workplace with cranes that climbs up with the construction). Those structures are usually assembled and, after the end of construction work, dismantled and transported to the next project or a warehouse. And this happens repeatedly.

This traditional construction method has many disadvantages and causes a lot of unnecessary extra work, costs, delays, loss of turnover and many unnecessary kilometres of transport work which is environmentally unfriendly in terms of air quality, noise pollution and damage to infrastructure, especially roads.

Construction using a lifting shed has some major disadvantages, as every lifting shed has a unique shape that is building dependent, a hoist shed or a lifting shed is a heavy and large structure that is custom built for only temporary use. At the end of the construction work, this entire structure is lowered back down, dismantled, transported, stored in a space and waiting there for the next job or activities to be adjusted first to the (different) dimensions of another tower. That lifting-lead cycle process is not economical, repeatedly claims delays and always extra costs due to missed opportunities and unnecessary construction work, and thus not environmentally friendly. One should also know that when a hoist shed is dismantled, the building or tower is definitely reduced in size by a few floors.

The present invention seeks to improve this situation by providing a solution indicated below.

The solution relates to a unique concept and an efficient construction method according to the invention to enable faster construction by, inter alia, avoiding as much unnecessary work as possible, speeding up the assembly time of building structures and building materials and minimising dismantling of, inter alia, hoisting cranes or as much as possible. Avoid temporary building constructions such as construction lift systems and a lifting shed. This saves a lot of costs, construction time, energy, and helps to significantly reduce unwanted substances and gases emissions due to unnecessary construction work and heavy transport in the construction industry, buildings can be commissioned earlier and faster that gives many benefits and offers many opportunities.

In order to achieve the concept's goal of faster, more sustainable and to build more cost-effectively, structures and components of building systems, machinery and building materials in the construction industry need to be redesigned in a better, more convenient and smarter way to properly combine functions and uses and give them multiple functions, and to better coordinate those structures, components and building materials to be used as permanent building materials and components of the building without having to dismantle and/or remove them again at the end of the construction process.

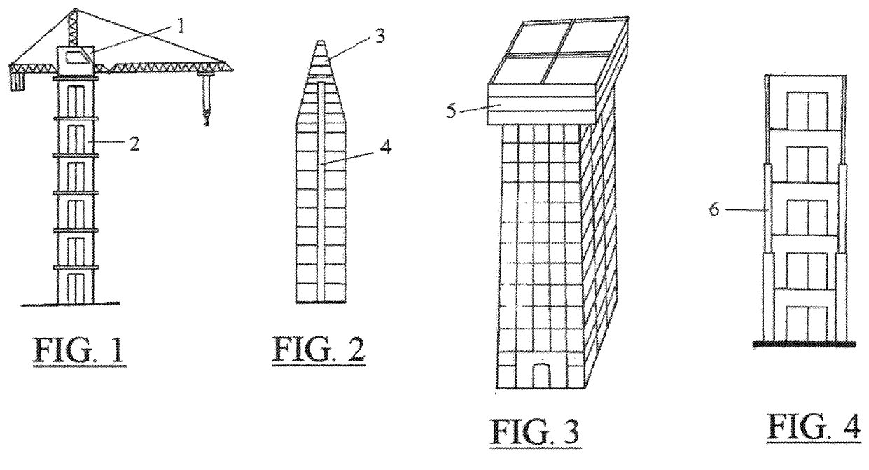

Example arises, by realising a new combination of a (partly temporary) crane together with a permanent lift system and redesigning it in a unique way. As suggested in FIG. 1, an advantageous concept arises and it becomes possible to use so many parts including the crane, such as the tower and the hoisting machine after the construction phase for permanent use as (parts of the) lift systems of a building, see FIG. 1 part 2. In this way, as many parts and structures as possible can conveniently and advantageously remain in (permanent) use in the building as parts and/or construction materials for the building facilities in order to avoid a lot of unnecessary and repeated construction work and a lot of transport work.

Implementation examples:
The shaft of the lift system of the building preferably with the stairs around it or next to it, the whole advantageous to use as the tower or the masters of the crane during construction for more construction speed especially for very high buildings and skyscrapers FIG. 1 and FIG. 2.
The rotating mechanism of the crane and the structure on top and the structures of the front boom and of the counter boom are designed in special ways and designs in order to be able to continue to use as many structures parts of the crane harmoniously as possible as construction materials and construction structures of permanent facilities for the building, intended also for a panoramic or decorative rotating roof or object or rotating part or a rotating space of it to be able to use advantageously permanent in the building as a restaurant or another kind of facility see FIG. 2 part 3 among to avoid as much temporary construction, dismantling work advantageously among other things to get more construction speed and to give the building a unique design character value among other things for advertising purposes and notoriety.
The shaft of the lift system with the stairs facility of the building used as the tower or masters of the crane can be constructed preferably from multiple prefabricated parts or ready-made segments, such as in the demonstrated manner in FIG. 1 part 2 for even more construction speed, efficiency and to be able to build with more safety and to avoid having to dismantle as many structures as possible and further use them as a permanent facility of the building. See FIG. 2 part 4.

Or described differently, the tower or the masters of the crane will be equipped with a lift system preferably with stairs next to or around it, the whole thing is designed in a special way for use during construction work and to be further integrated as part of the building and to continue to be used permanently as facilities of the building without having to remove them.
The hoisting machine of the crane with its electronic components can be used forever for the lift system in the building, or continue to be used permanently for the maintenance of the building. See FIG. 1 part 1

In another performance according to the invention, a product is designed with a new sustainable way to avoid the disadvantages of using a hoisting shed in the construction industry, among others. A product that is faster, more economical, environmentally friendly, and that enables an advantageous construction method.

By starting first with the construction of a moveable floor or space, hereinafter also referred to as a “workspace module”, with a roof and the necessary facilities for permanent use and during construction work such as sanitary facilities for improved working conditions.

The construction of that floor or space preferably consists of as many light building materials as possible and may possibly be realised from several separate parts or segments, which preferably can be raised independently of each other and can always be moved, lifted, slid or rolled upwards.

This floor or area of the building, see FIG. 3 part 5, temporarily becomes an ideal workstation for building the rest of the building's floors. A crane is preferably on rails and can move freely in x, y and z axis directions to reach all points and surfaces for all finishes inside and outside around the building. After a floor is finished, that movable floor or space is pushed or lifted further and further up to start a new floor, until the building reaches the desired height. Then the workshop in that moveable floor is cleared as required and from that moment on, the building is finally ready for use. The hoisting machinery and the electronic components that go with it is further used for the lift system facility or permanently for building maintenance.

This product with this construction concept is definitely more advantageous, as there are no heavy structures or workspace that need to be lowered and dismantled, among other things, with all the disadvantages this entails as well, making the building basically a few floors smaller, as is the case when using a hoist shed. But in the method of construction according to the invention, all or so many structures that are normally built temporarily for certain purposes and temporary use are now also continued to be used as part of the building, and at the end of construction work no or as little dismantling work follows, no heavy burden on the environment and no nuisance to the surrounding area caused by heavy transport, no delays due to unnecessary extra work, no storage spaces and adjustments of constructions for the next projects, but more construction speed, more turnover and more economic advantages and certainly no missed opportunities, because the building or tower keeps more height and more surface area, thus creating an advantageous complete product with its own high design character and a new way to build towers.
In an important performance to achieve, among other things, more construction speed in the construction industry as one of the important goals according to the invention, that the tower or masters of the crane built from a shaft of the lift system along with the stairs around it or next to it. The whole is built using telescopic profiles and structures, in that case as pillars for solution for faster construction. These telescopic pillars, see FIG. 4 part 6, can include a number of precisely fitting shapes such as tubes, which can be slid in and out of each other. These telescopic pillars are firmly riveted to the foundation, then pulled apart step by step and connected in time with columns, beams and walls, among other things, or with ready-made segments to form a solid and a stable structure and thus build further to the desired height. The use of these telescopic pillars with profiles running from thick to thin and from wide to narrow creates a structure with a combination of properties that becomes lighter and stronger as you build higher, provided that the rest of the construction components and building materials such as columns, beams and walls also continue to become narrower and lighter in proportion, this faster and practical construction method according to the invention can also be used advantageously for the rest of the construction of the entire building to save more time and costs, also because lighter and lighter construction is used as higher and higher construction is built, this is a sustainable, inexpensive and environmentally friendly solution, especially since this construction method requires a higher degree of precision and accuracy in the choice of construction material and the amount of material used in order not to use more than what is needed. See FIG. 4.
The stairs and the elevator facilities of the building, which according to the invention are used as the tower of the crane during the construction work, can advantageously be manufactured from prefabricated segments. See FIG. 1 part 2 and FIG. 2 part 4. These segments are provided in advance with all necessary parts, constructions, dimensions and pre-processes, the electronics components and as much prefabrication as possible for faster assembly and segments can be stacked on top of each other and connected to each other. to connect. The big advantage of this is the construction speed, the lower costs with which construction can be done, although it is possible to opt for poured concrete.

In skyscrapers, the advantage of using the shaft of the elevator system as the tower of the crane according to the invention is enormous, because one does not need a heavy separate tower for the cranes for only temporary use. that saves a lot of heavy assembly and disassembly work at extreme building heights, and especially in extreme weather conditions and that saves a lot of expensive costs, time and avoids, among other things, a lot of heavy transport nuisance, especially in busy cities, and prevents damage to the road surface and the environment.

The necessity, the advantages and the purposes of this new construction concept according to the invention for the construction industry and for the environment make this construction method effective and practical enough for application in all aspects, because it is now possible to use the temporary structures and components such as those of integrate a crane as permanent constructions of parts and facilities of a building. That is sustainable, efficient, fast, safe, economical and environmentally friendly enough to avoid the current classic building concepts.

What is claimed is:

1. Method for building a structure, in particular a relatively high, multi-storey building, comprising building the structure using construction aids, such as hoisting/or mounting means, which are at least partly adapted to act as functional part of the structure to be and remain permanently incorporated into the structure.

2. Method according to claim 1, wherein a tower and/or hoisting machine of a construction crane or construction lift is used as a permanent part of the construction, such as part of a lift installation, after the construction phase of the construction work.

3. Method according to claim 1, wherein a rotating mechanism of a construction crane is used after the construction phase of the structure as a permanent part of the structure, such as part of a panoramic and/or decorative revolving roof, revolving space or other revolving object of the structure.

4. Method according to claim 1, wherein use is made of a workspace module that can be moved vertically during the construction process, which is used after the construction phase of the structure as a permanent part of the structure, such as part of a permanent floor or space.

5. (canceled)

6. (canceled)

7. Construction hoisting device, in particular construction crane or construction lift, comprising a tower and/or hoisting machine which is adapted to be used as a permanent part of the construction, such as part of a lift installation, after the construction phase of a building.

8. Construction hoisting device, in particular construction crane, comprising a rotating mechanism, which is adapted to be used after the construction phase of a building as a permanent part of the building, such as part of a panoramic and/or decorative revolving roof, revolving space or other revolving object of the construction.

9. (canceled)

10. Method according to claim 2, wherein the tower of the construction crane is used as part of the lift installation during and after the construction phase of the construction work, wherein a shaft of the lift installation is constructed from multiple prefabricated parts or ready-made segments.

11. Method according to claim 10, further comprising using the construction crane to construct the shaft of the lift installation.

12. Method according to claim 3, wherein the rotating mechanism of the construction crane is used after the construction phase of the structure as part of a panoramic and/or decorative revolving roof and/or revolving space of the construction.

13. Construction hoisting device according to claim 7, wherein the construction hoisting device is a crane comprising a tower which is adapted to be used as part of a lift installation after the construction phase of the building, wherein a shaft of the lift installation is constructed from multiple prefabricated parts or ready-made segments.

14. Construction hoisting device according to claim 8, wherein the construction hoisting device is a construction crane comprising a rotating mechanism which is adapted to be used after the construction phase as part of a part of a panoramic and/or decorative revolving roof and/or revolving space of the construction.
